(19) United States
(12) Patent Application Publication
(10) Pub. No.: US 2008/0185487 A1
(43) Pub. Date: Aug. 7, 2008

(54) Power Tilt

(76) Inventor: Lawrence J. Beger, Chicago, IL (US)

Correspondence Address: CARDINAL LAW GROUP, Suite 2000, 1603 Orrington Avenue, Evanston, IL, 60201, US

(21) Appl. No.: 11/969,570

(22) Filed: Jan. 4, 2008

Related U.S. Application Data
(60) Provisional application No. 60/883,604, filed on Feb. 2, 2007.

(51) Int. Cl. F16M 11/06

(52) U.S. Cl. 248/220.21

(57) ABSTRACT

A video monitor mount includes a first piece adapted to be fastened to a wall and a second piece adapted to be fastened to a video monitor. The first piece includes a bubble level and a first mating component and the second piece includes a second mating component. The first piece or the second piece comprises an extension arm having a rotation joint that comprises a brass bushing.

### RELATED APPLICATION

This application claims the benefit of and priority to U.S. Provisional Application No. 60/883,604 titled POWER TILT filed Jan. 5, 2006 and refiled on Feb. 2, 2006, the entirety of which is incorporated by reference.

### FIELD OF THE INVENTION

The present invention is directed to a mount for a video monitor. More specifically, the invention is directed to a wall mount for mounting a flat panel television or video monitor.

### BACKGROUND OF THE INVENTION

Current video monitor technology is moving rapidly to flat screens. LCD and plasma screens are popular flat screen products. These flat screens can be mounted in a traditional manner on a horizontal surface by placement on a stand. It is also now popular to mount flat screens on a wall. Problems with mounting flat screens onto a wall include making sure that the screen is level. Also, a cord or cords that are connected to the back of the flat screen monitor can give a messy appearance. Further, rotating support arms can be “sticky” and prevent easy rotation of the mounted monitor. Finally, the installation process itself can be difficult or frustrating. An installer may never know if the mount is actually, properly placed together. If improperly assembled, then there is a possible situation of an unstable mounting relationship.

It is an object of the present invention to provide a wall mount that overcomes these and other disadvantages.

### SUMMARY OF THE INVENTION

The present video monitor mount includes a combination of features directed to mounts for flat screen monitors for television, video, and computer applications. The mounts include one or more of an integral bubble level, a cord management hook, an audible click installation spring and a brass bushing/stainless steel rotating joint. Additionally, the mounts include a motor driving a power tilt gear to control the rotation of a tilt bar.

### BRIEF DESCRIPTION OF THE DRAWINGS

FIG. 1 is an exploded perspective view of an embodiment of the present mount.

FIG. 2-5 are perspective, side, elevation, top elevation and rear views, respectively, of a second embodiment of a mount described herein.

FIG. 6-9 are perspective, side elevation, top elevation and rear views, respectively, of another embodiment of a mount as described herein.

FIG. 10 is a perspective, exploded view of a fourth embodiment of a mount as described herein.

FIGS. 11 and 12 are exploded, perspective views of mounts like those shown in FIGS. 2-9.

FIG. 13 is a perspective view of a fifth embodiment of a mount as described herein.

FIG. 14 is an exploded perspective view of the mount shown in FIG. 13.

FIG. 15 is a perspective view of a portion of the mount shown in FIG. 13 focusing on the cord management hook feature of the mount.

FIGS. 16A and 16B are rear elevation views of the mount shown in FIG. 13.

FIGS. 17A to 17C are side elevation views of the mount shown having a flat screen monitor mounted on it in various tilt positions.

FIG. 18 illustrates a perspective view of one embodiment of a mount in accordance with one aspect of the invention.

FIG. 19 illustrates one embodiment of a power tilt gear, in accordance with one aspect of the invention.

### DETAILED DESCRIPTION OF THE PREFERRED EMBODIMENTS

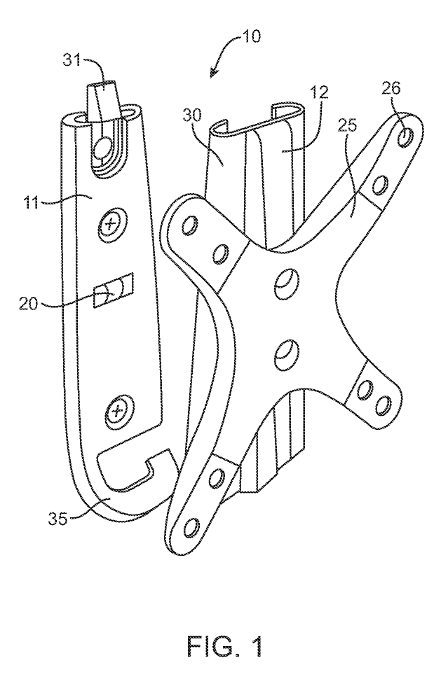

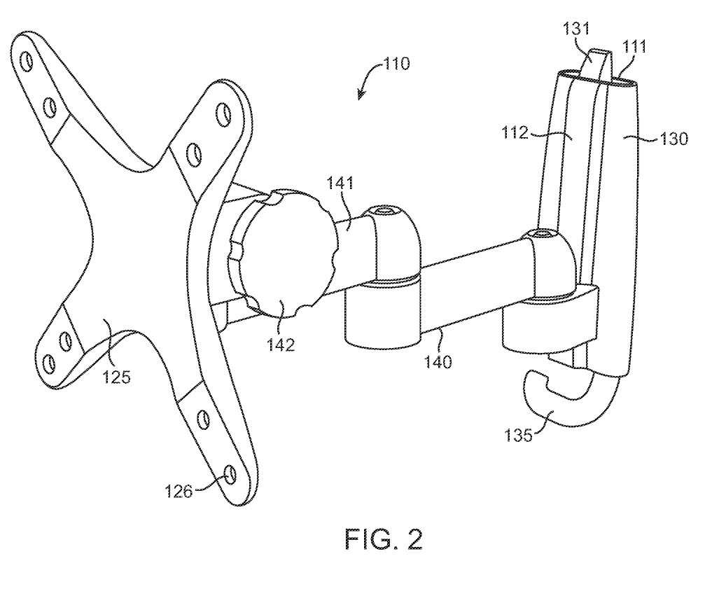

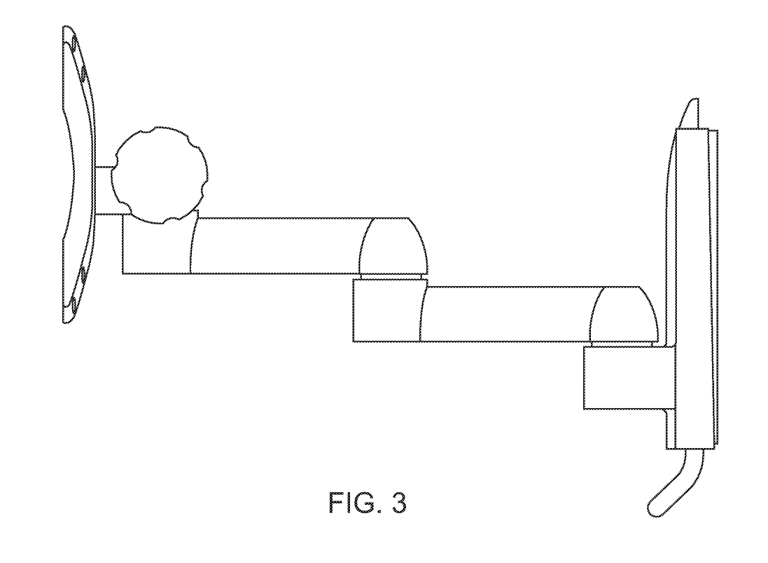

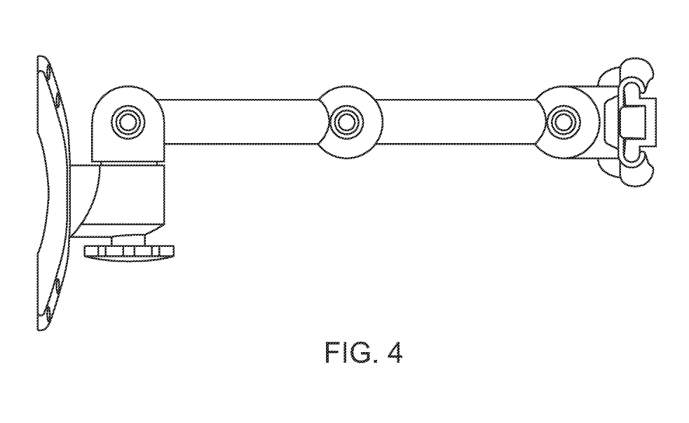

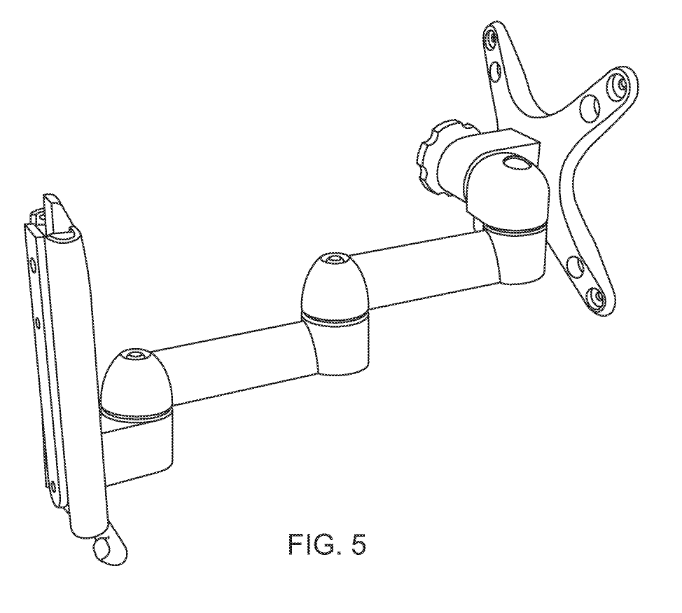

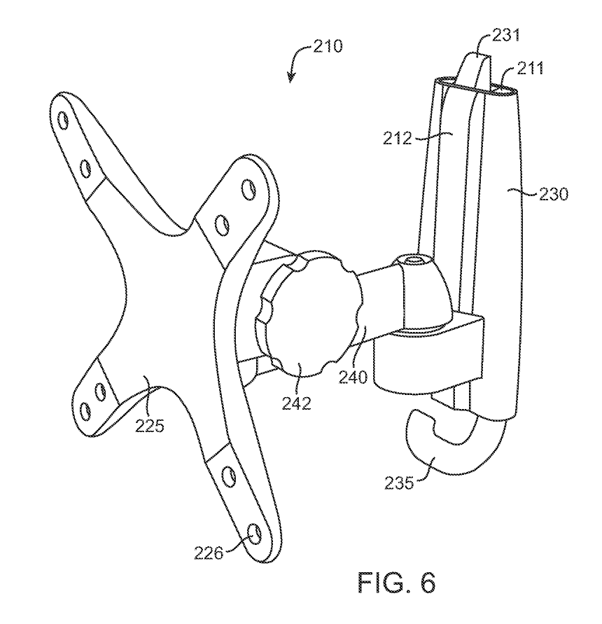

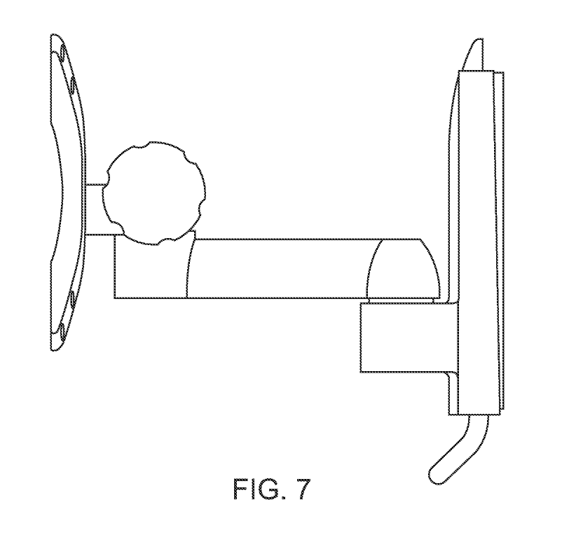

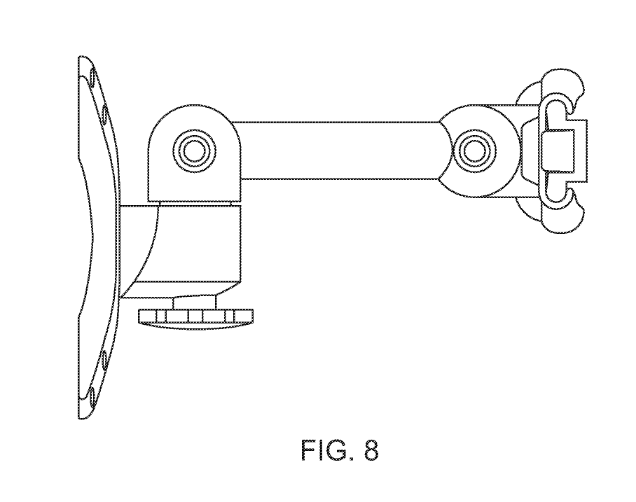

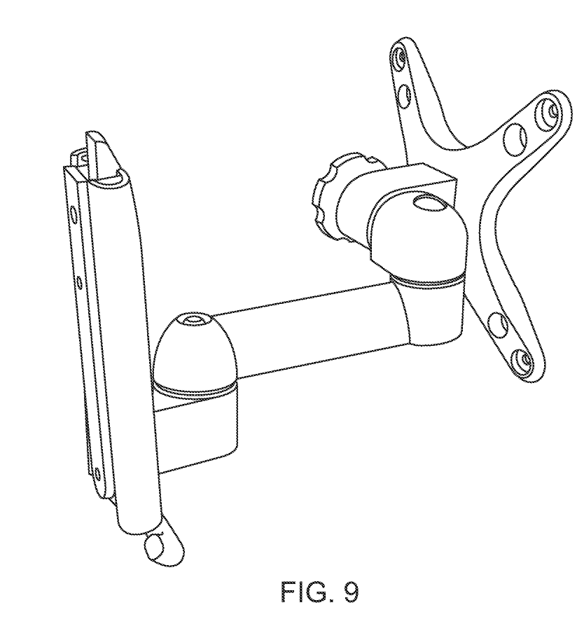

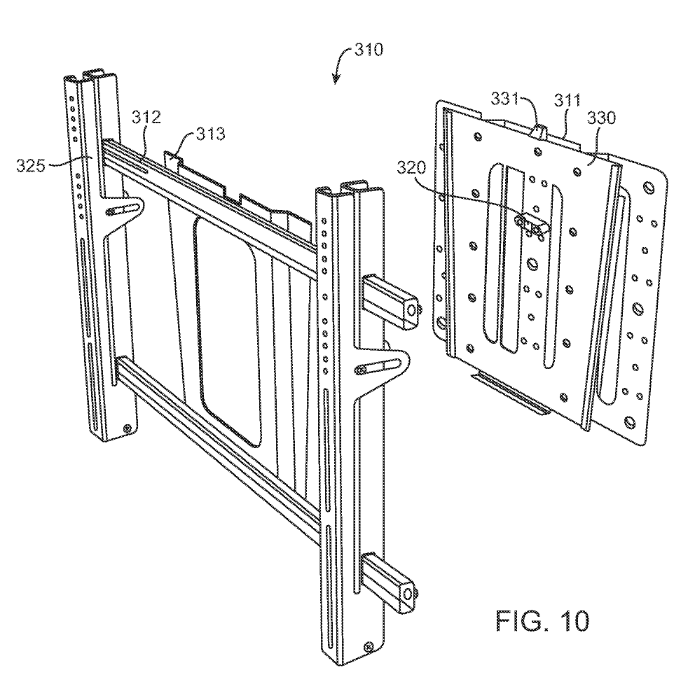

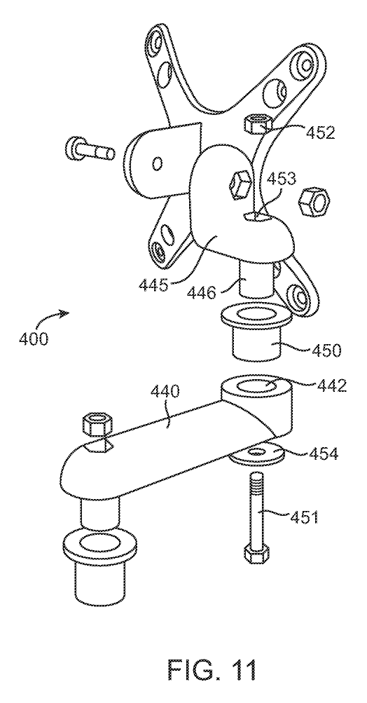

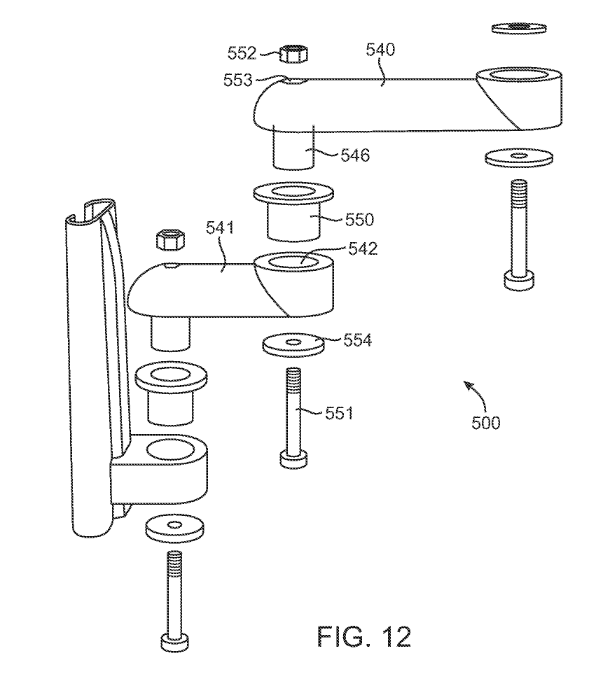

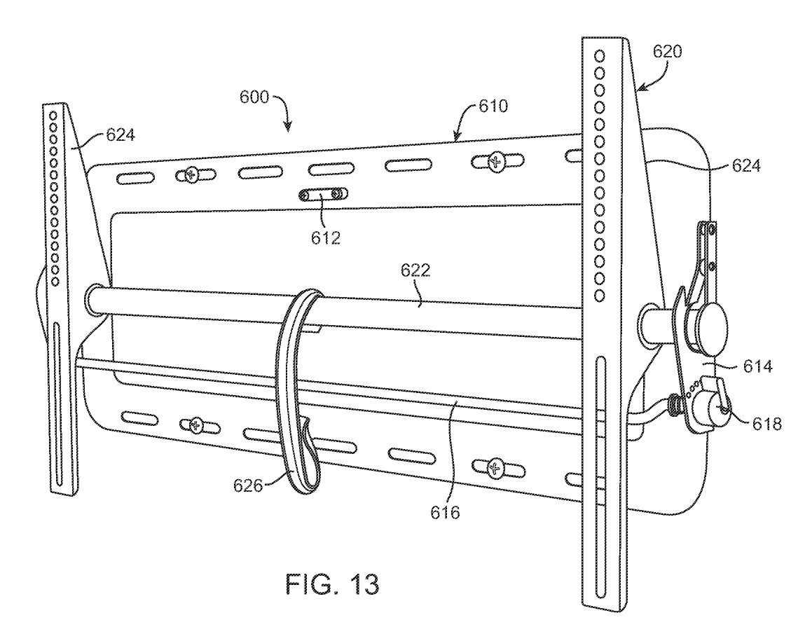

The attached figures are alternative examples of mounts in accordance with the present invention. FIG. 1 is a perspective view of a simple, wall-flush mount 10. FIGS. 2 through 5 are perspective, right side elevation, top, and rear perspective views of an alternative embodiment of the present mount having two extension arms. FIGS. 6 through 9 are perspective, right side elevation, top, and rear perspective views of a still further embodiment of the present mount having a single extension arm. FIG. 10 is a perspective view of a third alternative embodiment of the mount. FIGS. 11 and 12 are exploded views that display some of the working components of the support arms. FIGS. 13-17 show various view of a still further embodiment of the mount described herein. Of course, other variations and configurations of the present mount may be developed that include one or more of the distinctive features of the present invention.

In FIG. 1, the mount 10 includes a two piece system having a wall piece 11 and a monitor piece 12. The wall piece 11 is adapted to be mounted on a wall or other vertical surface. The wall piece 11 includes a bubble level 20 to ensure that the wall piece is mounted in a vertical fashion. The wall piece 11 also includes a cord management hook 35 adapted to organize and retain the cords that feed into and out of the back of the monitor. At the top of the wall piece 11 is a spring lock 31. In FIG. 1, the wall piece 11 embodies a male mounting component. When the monitor piece 12 is mounted in a sliding fashion over the wall piece 11, the spring retainer 31 will give an audible snap to let an installer know that the mounting piece 12 has been fully and properly engaged over the wall piece 11. The spring retainer 31 releasably locks the monitor piece 12 in place on the wall piece 11. The shape of the wall piece 11 enables it to be a male mating component and is more narrow at the top and diverges at least partly so that the middle or base of the wall piece is wider than the top. The mounting piece 12 includes a sleeve that is a female mating component 30 corresponding to the shape of the wall piece 11 and is matingly received thereon. The female component 30 slides down over and around the wall piece 11. As a friction fit, the female component 30 will press against the retaining clip 31 until it has slid completely over the wall piece 11. The mounting piece 12 also includes an “X” component 25 that is used to attach to the back of a video monitor. There are included multiple holes 26 that correspond to a broad range of monitor products and make it attachable to the back of the monitor.

FIGS. 2 through 5 illustrate an alternative embodiment of the mount 110. In this embodiment of a mount 110 there is also a wall piece 111 that includes a bubble level (not shown) a spring clip 131 and a cord management hook 135. This wall piece 111 is functionally identical to the wall piece 11 described earlier. Likewise, the female piece 112 includes a female component 130 that mounts over the wall piece 111 in a fashion similar to the monitor piece 12 described earlier. There is shown an “X” component 125 having holes 126 for fastening to the back monitor. The additional; features of this mount 110 include the extension arms 140 and 141 that are rotatably connected to each other. There is a further knob 142 that allows the “X” component 125 to be swiveled or rotated upwardly or downwardly to direct the face of a connected monitor in a desirable direction.

FIGS. 6 through 9 illustrate a still further embodiment of a mount 210. This mount includes the wall piece 211 having an integral bubble level (not shown). There is also a cord management hook 235 and a mounting spring clip 231. The female piece 212 includes a female component 230 that functions similarly to that female component 30 described in connection with FIG. 1. There is also an “X” component 225 that is adapted to fasten to the back of the monitor. Holes 226 are provided to fasten the mount to the back of the monitor. In this embodiment 210, a single extension arm 240 is rotatably connected to the mount piece 212. Similarly, there is a screw knob 242 to allow for up and down rotation similar to the knob 142 described in connection with FIGS. 2 through 5.

FIG. 10 illustrates a third embodiment of a mount 310. This mount includes the wall piece 311 having an integral bubble level 320. There is also a mounting spring clip 331. The wall piece 311 further includes a female mating component 330 attached to it. The monitor piece 312 includes a male mating component 313 fixed to it. The male component 313 is adapted to be received in the female component 330. The female component 330 is wider at its top than at its base to thereby receive and hold secure the male component 313. Once the male component 313 is fully inserted within the female component 330, the mounting spring clip 331 will lock the mounting component 312 in place. The monitor component 312 further includes braces 325 which are adapted to be fastened to the back of a monitor. The braces 325 are at least partially rotatably connected to the monitor piece 312 so that a monitor may be titled forward or back with respect of the mount.

The video monitor that is supported by the present mounting system can be quite heavy. Accordingly, for any system which includes the rotation joints shown, for instance, in the mounts of FIGS. 2-9, the movement of the extension arms must be made smooth and simple to make the mount effective. If the joints have a high level of friction between them, then the rotation feature becomes difficult to exercise if possible at all. A “sticky” or “jerky” movement may risk a failure of the whole system if a user tries to force the movement of the monitor. Turning now to FIGS. 11 and 12, there is shown the use of a brass bushing 450 and 550 to facilitate the smooth and easy rotation of those joints. Specifically with reference to FIG. 11, the mounting apparatus 400 includes a support arm 440. This support arm 440 supports the ultimate bracket 445 that ultimately carries the mounting support for a monitor. Support arm 440 includes a vertical aperture 442 in which is mounted a round bushing 450. The bracket 445 includes a male rod 446 that is received inside the cylindrical aperture inside the bushing 450. A bolt 451 passes through a washer 454 and through the male post 446 where it is secured to a nut 452 that is seated in an aperture 453 of the bracket 454. Once tightened, the bracket 445 is able to be rotated about on independent of the arm 440. This rotation is simplified by the brass bushing 450 coupled with the stainless steel bolt 451 and the other metal components 446 and 442 that come in contact with the brass bushing. The softness and durability of the brass bushing 450 facilitate easy rotation yet durability for a mounting apparatus.

FIG. 12 is another view showing the use of a brass bushing 550 in connection with a dual support arm 540 and 541 system. The support arms 540 and 541 are rotatably connected through use of a post component 546 of support arm 540 that is received in the cylindrical aperture in the middle of the brass bushing 550. The brass bushing 550 is received in the circular aperture 542 of the second support arm 541. A stainless steel bolt 551 passes through a washer 554 and is threaded into a nut 552 that is seated within the aperture 553. As described in connection with FIG. 11, the soft nature of the brass bushing in connection with the remaining steel parts of the support arm provide for smooth and easy rotation of the support arms with respect to each other.

As shown, but not further described in the drawings, other brass bushings may be used in connection with each rotating joint to ensure that the entire rotating function and swivel function of the mount is made simple and smooth.

In each of the embodiments of the mounts described herein, there is both a male mating component and a female mating component. Each of the mounts is a two piece or two component system where the male component embodies or is a part of and fixed to one piece and the female component is a part of or embodies the other piece. In this two component system, the wall mount component is able to be fixed on a wall in a level fashion using the integral bubble level. The male/female pieces are then engineered so that they fit the male piece within the female piece to likewise be oriented in a level manner. The audible click of the spring clip in each case allows a user to have confidence with respect to the proper installation of the female component about the male component or vice versa. The respective clips also provide the extra insurance that the mount will not allow the monitor which it is supporting to slide out of place.

The material used to manufacture all of the components of the present invention must be rigid and durable enough to support the weight of a video monitor. Different polymers and composites may be acceptable. Also, metal pieces including aluminum or steel may be used to accomplish the present purpose. With respect to the cord management hooks 35, 135, and 235, this is a hook provided at the bottom of the respective wall piece that allows for cables going into and out of the monitor to be collected and stored together. In each case, the spring clip 31, 131, and 231 must be made of a resilient material that provides an audible snap action once the mount is correctly assembled. This snap will provide an audible confirmation to an installer that the mounting assembly is correctly pieced together.

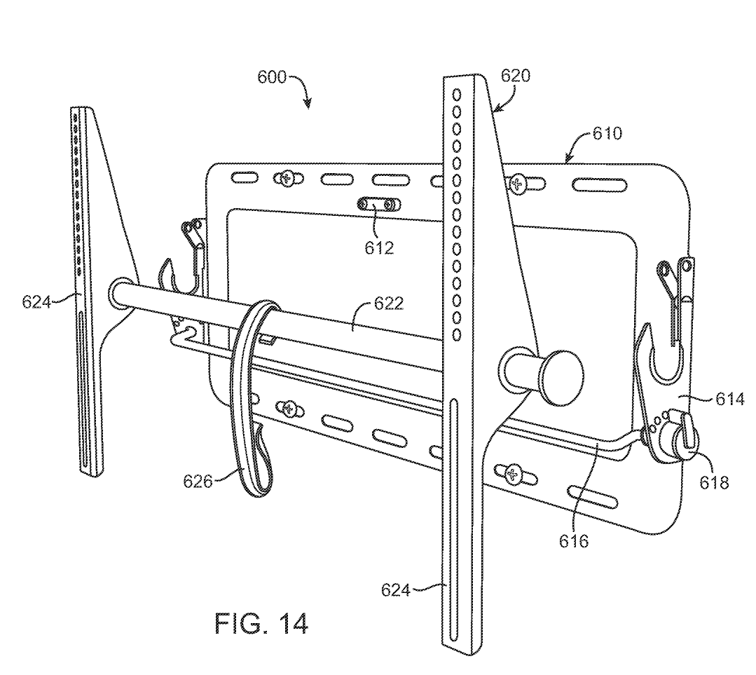

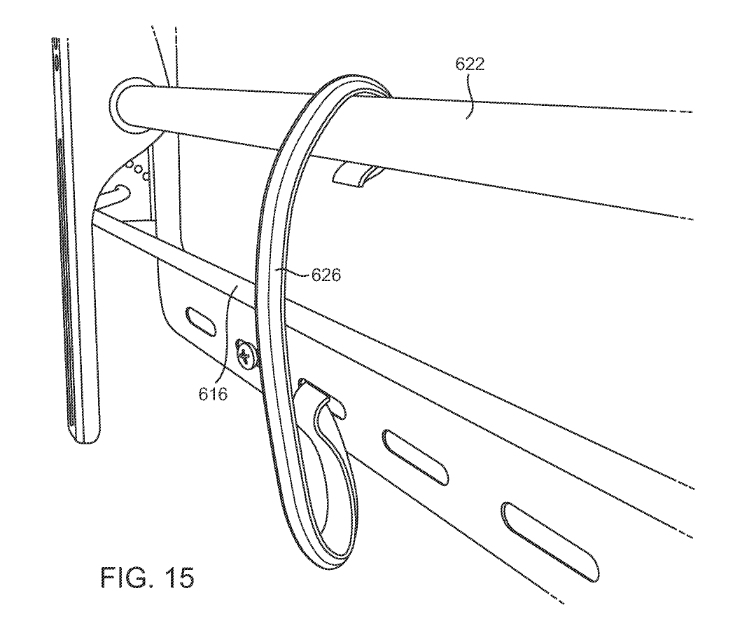

FIGS. 13-17 illustrate a still further embodiment of a mount in accordance with the present invention. The mount 600 includes a wall piece 610 having an integral bubble level 612. The wall piece 610 further includes a pair of cradles 614. The monitor piece 620 includes a pair of vertical braces 624 that are adapted to be fashioned to the back of the monitor. The brackets 624 are rotatably mounted to a support bar 622. The support bar 622 rests in and is carried by the cradle 614 of the wall piece 610. The monitor piece further includes a cord management hook 626. The pitch of the brackets 624 may be varied by tilt bar 616 that can be adjusted through using knob 618. The tilt bar 616 and knob 618 are attached to the cradle 614 portion of the wall piece 610. FIGS. 13 and 14 shown the assembled and exploded views of the mount 600 as described. FIG. 15 is directed primarily to the cord management hook 626 that is adapted to be hung from the support bar 622. It may be slid to various locations along that support bar 622. The hook 626 is fabricated of a durable but flexible plastic material.

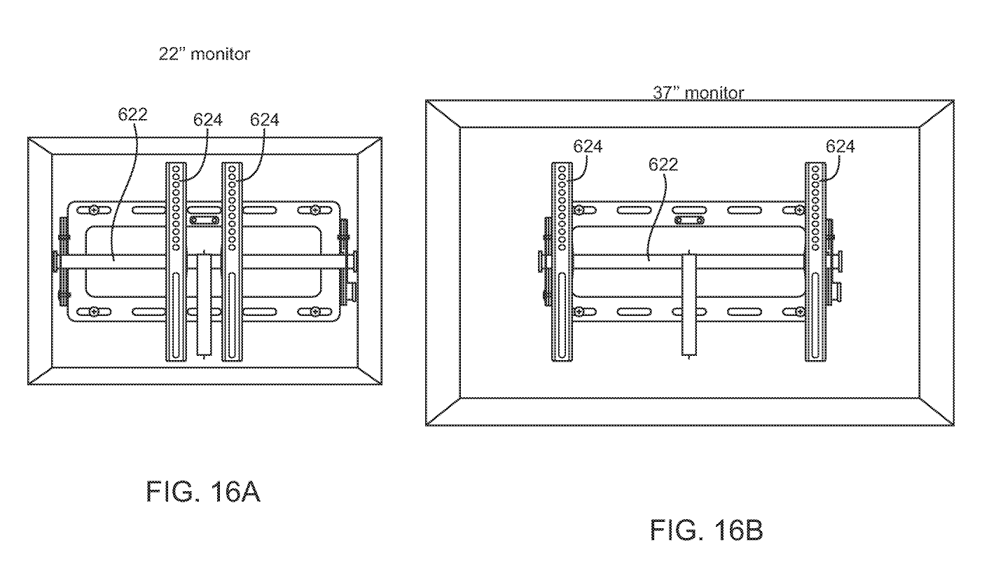

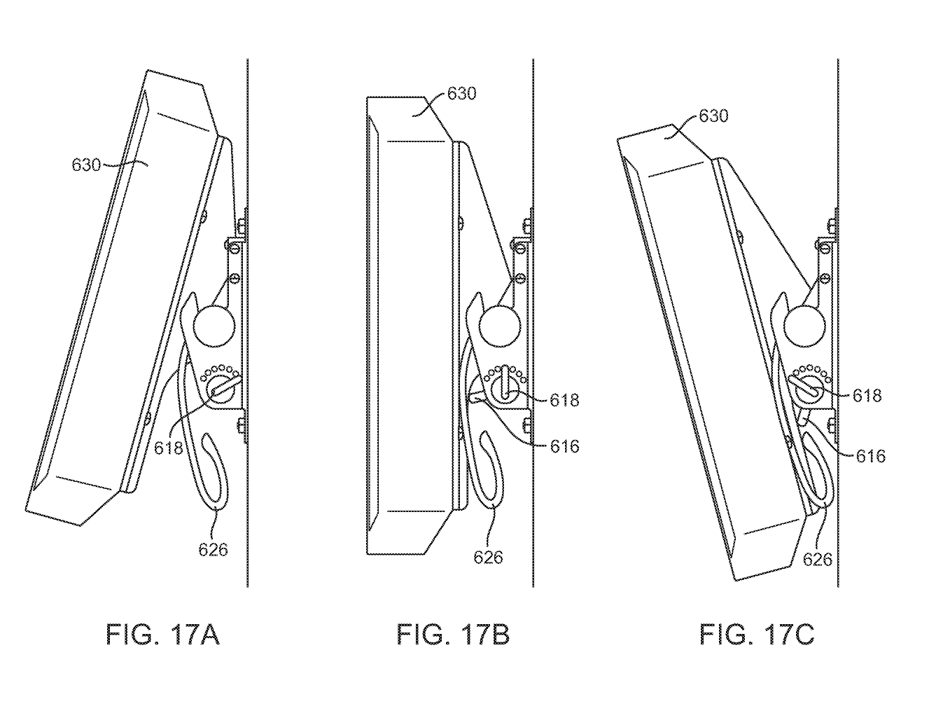

FIGS. 16A to 17C demonstrate the variability of the mount 600. In FIGS. 16A and 16B, the mount 600 is shown with bracket 624 in a tight or narrow configuration on the support bar 622 (FIG. 16A) and also in the wide or spread position on the support bar (FIG. 16B). FIGS. 16A to 16B illustrate that the mount may be used in connection with a broad range of monitors having different points of attachment along their lateral length on the back of the monitor. FIGS. 17A to 17C demonstrate how the monitor 630 may be mounted at variable pitches. The knob 618 will turn the tilt bar 616 in such degrees as to tilt monitor upwardly, parallel to a wall or downwardly. The cord management hook 626 is shown as being able to be flexibly manipulated to allow for all of the different pitch courses for the mount.

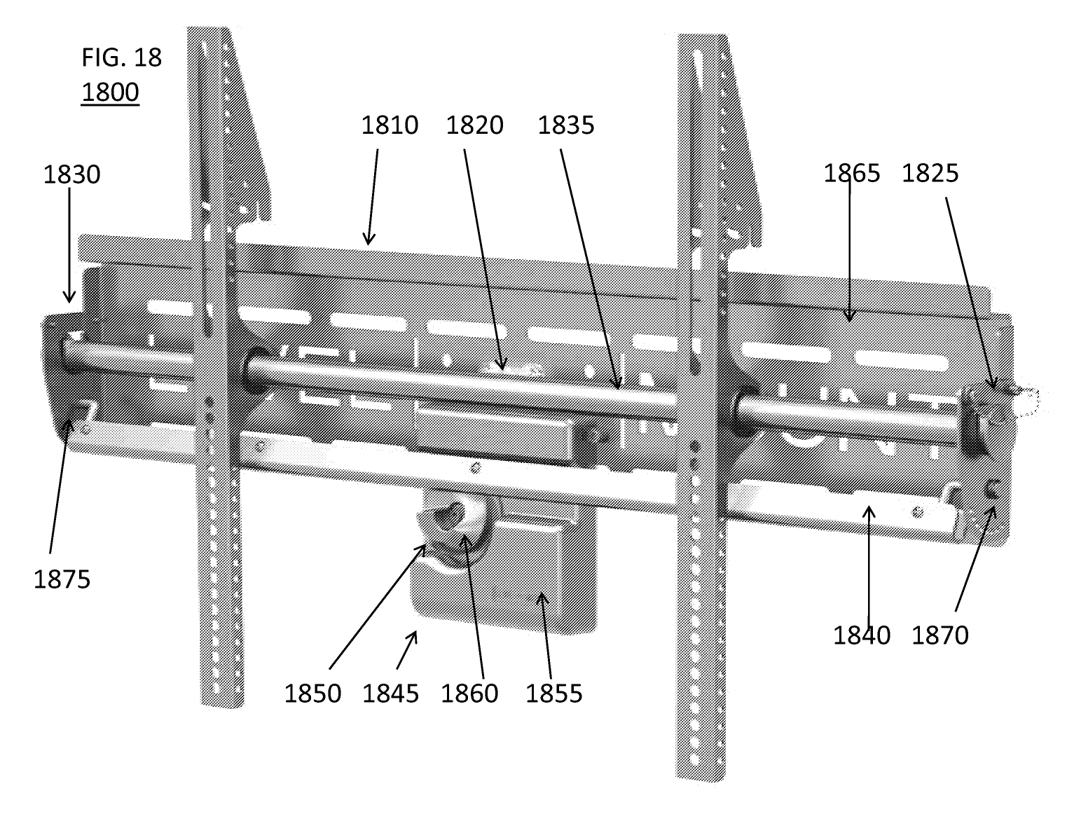

FIG. 18 illustrates a video monitor mount 1800 in accordance with another aspect of the invention. Mount 1800 includes a wall piece 1810 having an integral bubble level 1820. Wall piece 1810 includes a first cradle 1825 and a second cradle 1830 separated from the first cradle 1825. Additionally, mount 1800 includes a support bar 1835 configured to be supported by the first cradle 1825 and second cradle 1830. The support bar 1835 is configured to extend between the first cradle 1825 and second cradle 1830, and the support bar is configured to rotate within the first cradle 1825 and second cradle 1830. Furthermore, mount 1800 includes at least a first tilt bar 1840 substantially parallel to, and separated from, the support bar 1835.

Mount 1800 further includes a power tilt device 1845 attached to the wall piece 1810. Power tilt device 1845 includes a power tilt gear 1850 and a motor 1855, the power tilt gear 1850 driven by motor 1855. Power tilt gear 1850 includes a spiral ramp 1860. The first tilt bar 1840 contacts the spiral ramp 1860, and operation of motor 1855 rotates the power tilt gear 1850 changing the position of the first tilt bar 1840. Motor 1855 is any motor with sufficient power to rotate the power tilt gear given a known design load. The motor 1855 can be exposed, or contained within a housing. Motor 1855 is connected to a power supply, and in one embodiment, the motor 1855 further includes a receptacle configured to provide power to a television monitor mounted upon the mount 1800. In one embodiment, motor 1855 drives the power tilt gear 1850 with a worm gear. In one embodiment, motor 1855 drives the power tilt gear 1850 with a hydraulic device.

In one embodiment, the spiral ramp includes a ramp portion extending between an origin and a termination, wherein the origin and termination are disposed adjacent each other circumferentially, and wherein the origin and termination are offset vertically. In such embodiments, an abrupt ‘jump’ exists between the origin and termination of the spiral ramp. In other embodiments, there is no vertical offset between the origin and termination of the spiral ramp.

In one embodiment, mount 1800 includes a second power tilt device attached to the wall piece on a side opposing the side where the first power tilt device is mounted. In such embodiments, the mount is configured to tilt a monitor both up and down. In one such embodiment, each of the first power tilt device and second power tilt devices are controlled by a controller, such as an ASIC or general purpose controller.

In one embodiment, the power tilt device 1845 is in communication with and controlled by a remote control, such as a wired or wireless device. The power tilt device receives control signals from the remote control and actuates the motor responsive to the received control signals. The remote control can operate using appropriate technology, such as either RF or IR signals, as well as a direct wired connection.

With the exception of the power tilt device, the features of mount 1800 are similar to the mounts disclosed above, and especially the mounts illustrated in FIGS. 16A and B, as well as FIGS. 17A, 17B, and 17C. Therefore, the discussion of mount 1800 will be primarily focused on the features of the power tilt device, as greater detail for the other features is contained above.

In one embodiment, the wall piece 1810 includes a substantially planar base portion 1865 connecting a first wall portion 1870 and a second wall portion 1875. The first tilt bar 1840 rotates between a down position wherein the first surface is substantially parallel with the base portion 1865 and an up position wherein the first surface defines a non-zero angle with respect to the base portion 1865.

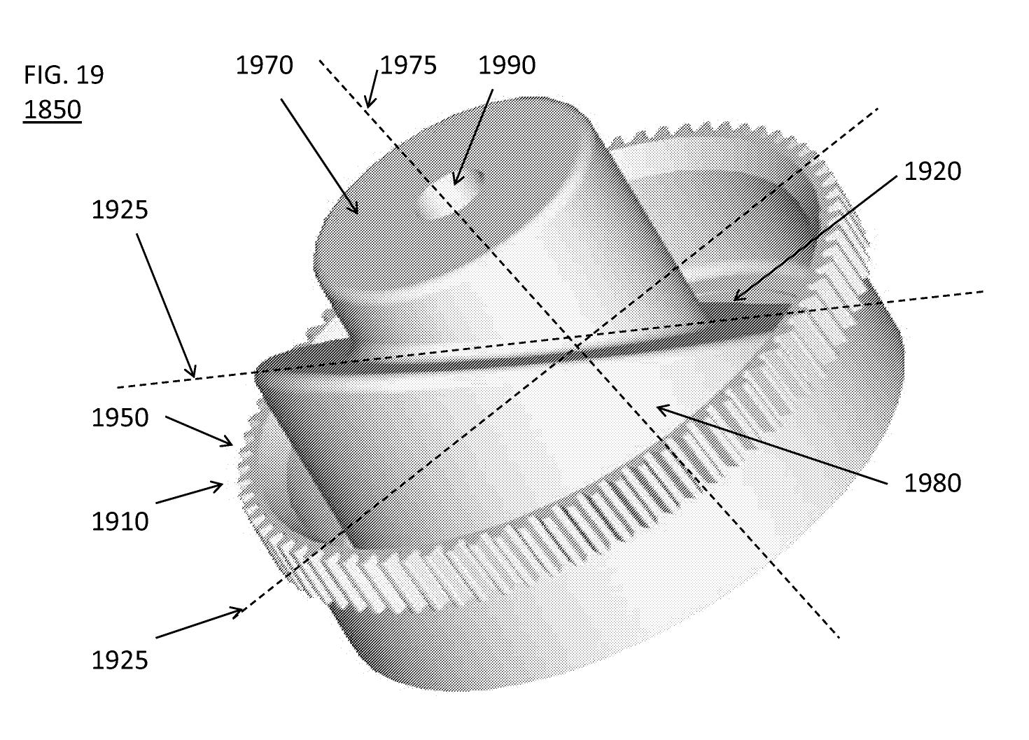

In one embodiment, the mount includes a power tilt device including a motor and a power tilt gear driven by the motor. FIG. 19 illustrates one embodiment of the power tilt gear 1850 in accordance with one aspect of the invention. Power tilt gear 1850 includes a tooth portion 1910 in communication with the motor 1855 (not shown in FIG. 19) and a ramp portion 1920, wherein the tooth portion 1910 defines at least a first tooth plane 1915 and wherein the ramp portion 1920 defines a ramp plane 1925, wherein the ramp plane 1925 defines a non-zero angle relative the first tooth plane 1915, and wherein the tooth portion defines a tooth circumference 1950 surrounding the ramp portion 1920. In one embodiment, power tilt gear 1850 further includes a cylindrical portion 1970 defining a cylindrical axis 1975 substantially perpendicular to the first tooth plane 1915. The ramp portion 1920 defines a ramp circumference 1980 surrounding the cylindrical portion 1970. The cylindrical portion 1980 includes a reception hole 1990 substantially coaxial with the cylindrical axis 1975.

The tilt bars disclosed herein, such as tilt bar 840 and 616 can vary between embodiments. In one embodiment, the tilt bar includes an elongate member defining a first axis and a second axis parallel with the first axis. A first bent portion and second bent portion bend the tilt bar so that the tilt bar extends further out from the base portion. In one embodiment, the tilt bar includes a first portion, second portion, third portion, fourth portion, and fifth portion, wherein the first portion and fifth portion are substantially coaxial, the second portion and fourth portion are set apart and define substantially parallel portion axes, and the third portion defines a third portion axis substantially parallel with the coaxial axes of the first portion and fifth portion, such that the first portion and second portion are connected with a first bent portion, the second portion and third portion are connected with a second bent portion, the third portion and fourth portion are connected with a third bent portion, and the fourth portion and fifth portion are connected by a fourth bent portion. In one embodiment, at least a portion of the third portion is covered with a covering bar. The covering bar includes at least a first surface and a second surface. The first surface and second surface are substantially perpendicular to each other, and are connected at a radiused portion. In one embodiment, the covering bar further includes a third surface, such that the third surface is substantially parallel with the first surface, and the third surface is connected to the second surface at a radiused portion.

In one embodiment, the tilt bar interfaces with monitor brackets to control the angle of a mounted television with reference to the surface supporting the mount. The monitor brackets rest on the tilt bar, and the tilt bar rests on the spiral ramp portion of the power tilt device, so that operation of the motor rotates the power tilt gear, changing the relative position of the spiral ramp so that the tilt bar moves circumferentially, and moves the monitor brackets resting on the tilt bar.

Other variations and combinations of features will be apparent to those with skill in the art. Those variations are included within the disclosure herein.

What is claimed is:

1. A video monitor mount comprising:
a wall piece having an integral bubble level, the wall piece including a first cradle and a second cradle separated from the first cradle;
a support bar configured to be supported by the first cradle and second cradle, and wherein the support bar is configured to extend between the first cradle and second cradle, and wherein the support bar is configured to rotate within the first cradle and second cradle;
at least a first tilt bar substantially parallel to the support bar, the first tilt bar separated from the support bar; and
a power tilt device attached to the wall piece, the power tilt device including a power tilt gear and a motor, the power tilt gear driven by the motor, the power tilt gear including a spiral ramp, wherein the first tilt bar contacts the spiral ramp, and wherein operation of the motor rotates the power tilt gear changing the position of the first tilt bar.

2. The mount of claim 1, wherein the wall piece comprises a first wall portion and a second wall portion, and wherein the first cradle extends from the first wall portion at an angle not parallel with the wall portion, and wherein the second cradle extends from the second wall portion at an angle not parallel with the wall portion, and wherein the first cradle comprises a first latch, and wherein the second cradle comprises a second latch, and wherein the first latch is configured to alternate between an open configuration such that the support bar can be placed in the first cradle and a closed configuration such that the support bar cannot be removed from the first cradle, and wherein the second latch is configured to alternate between an open configuration such that the support bar can be placed in the second cradle and a closed configuration such that the support bar cannot be removed from the second cradle.

3. The mount of claim 2 wherein at least one of the first cradle and second cradle further comprises a screw hole and wherein at least one of the first latch and second latch comprises a screw hole matched with the screw hole of the first cradle or second cradle, and wherein the latch is locked in position when a screw is inserted between the latch and cradle.

4. The mount of claim 2 wherein the first tilt bar includes at least a first surface and a second surface, the first surface substantially perpendicular to the second surface and wherein the first surface and second surface interface at a radiused portion, and wherein the first tilt bar extends between the first wall portion and second wall portion.

5. The mount of claim 4 wherein the wall piece includes a base portion connecting the first wall portion and the second wall portion, and wherein the base portion is substantially planar, and wherein the first tilt bar rotates between a down position wherein the first surface is substantially parallel with the base portion and an up position wherein the first surface defines a non-zero angle with respect to the base portion.

6. The mount of claim 1 further comprising a first monitor bracket including a first aperture and a second monitor bracket including a second aperture, and wherein the support bar is configured to slide within the first aperture and second aperture and wherein the first monitor bracket slides with respect to the support bar independent of the second monitor bracket and wherein the second monitor bracket slides with respect to the support bar independent of the first monitor bracket.

7. The mount of claim 1 further comprising a first monitor bracket including a first aperture and a second monitor bracket including a second aperture, and wherein the support bar is configured to slide within the first aperture and second aperture and wherein the first monitor bracket slides with respect to the support bar independent of the second monitor bracket and wherein the second monitor bracket slides with respect to the support bar independent of the first monitor bracket, and wherein the first monitor bracket includes a plurality of screw holes and a first channel, and wherein the second monitor bracket includes a plurality of screw holes and a second channel, and wherein the number of screw holes on the first monitor bracket is the same as the number of screw holes on the second monitor bracket.

8. The mount of claim 1 wherein the motor drives the power tilt gear with a hydraulic device.

9. A video monitor mount comprising:
a wall piece having an integral bubble level, the wall piece including a first cradle and a second cradle separated from the first cradle, wherein the wall piece comprises a first wall portion and a second wall portion, wherein the first cradle extends from the first wall portion at an angle not parallel with the wall portion, and wherein the second cradle extends from the second wall portion at an angle not parallel with the wall portion, and wherein the first cradle comprises a first latch, and wherein the second cradle comprises a second latch;
a support bar configured to be supported by the first cradle and second cradle, and wherein the support bar is configured to extend between the first cradle and second cradle, and wherein the support bar is configured to rotate within the first cradle and second cradle;
at least a first tilt bar substantially parallel to the support bar, the first tilt bar separated from the support bar;
a power tilt device attached to the wall piece, the power tilt device including a power tilt gear and a motor, the power tilt gear driven by the motor, the power tilt gear including a spiral ramp, wherein the first tilt bar contacts the spiral ramp, and wherein operation of the motor rotates the power tilt gear changing the position of the first tilt bar;
a first monitor bracket including a first aperture and a second monitor bracket including a second aperture, and wherein the support bar is configured to slide within the first aperture and second aperture and wherein the first monitor bracket slides with respect to the support bar independent of the second monitor bracket and wherein the second monitor bracket slides with respect to the support bar independent of the first monitor bracket;
wherein the first latch is configured to alternate between an open configuration such that the support bar can be placed in the first cradle and a closed configuration such that the support bar cannot be removed from the first cradle, and wherein the second latch is configured to alternate between an open configuration such that the support bar can be placed in the second cradle and a closed configuration such that the support bar cannot be removed from the second cradle, and wherein the first tilt bar includes at least a first surface and a second surface, the first surface substantially perpendicular to the second surface and wherein the first surface and second surface interface at a substantially rounded portion, and wherein the first tilt bar extends between the first wall portion and second wall portion, wherein the wall piece includes a base portion connecting the first wall portion and the second wall portion, and wherein the base portion is substantially planar, and wherein the first tilt bar rotates between a down position wherein the first surface is substantially parallel with the base portion and an up position wherein the first surface defines a non-zero angle with respect to the base portion.

10. The mount of claim 9 wherein the first monitor bracket includes a first aperture and the second monitor bracket includes a second aperture, and wherein the support bar is configured to slide within the first aperture and second aperture and wherein the first monitor bracket slides with respect to the support bar independent of the second monitor bracket and wherein the second monitor bracket slides with respect to the support bar independent of the first monitor bracket.

11. The mount of claim 10 wherein the first monitor bracket includes a plurality of screw holes and a first channel, and wherein the second monitor bracket includes a plurality of screw holes and a second channel, and wherein the number of screw holes on the first monitor bracket is the same as the number of screw holes on the second monitor bracket.

12. A mount comprising:
a power tilt device, the power tilt device including a motor and a power tilt gear, the power tilt gear driven by the motor, the power tilt gear including a tooth portion in communication with the motor and a ramp portion, wherein the tooth portion defines at least a first tooth plane and wherein the ramp portion defines a ramp plane, wherein the ramp plane defines a non-zero angle relative the first tooth plane, and wherein the tooth portion defines a tooth circumference surrounding the ramp portion.

13. The mount of claim 12 further comprising:
a cylindrical portion; the cylindrical portion defining a cylindrical axis substantially perpendicular to the first tooth plane, and wherein the ramp portion defines a ramp circumference surrounding the cylindrical portion, and wherein the cylindrical portion includes a reception hole substantially coaxial with the cylindrical axis.

14. A video monitor mount comprising:
a wall piece having an integral bubble level, the wall piece including a first cradle and a second cradle separated from the first cradle;
a support bar configured to be supported by the first cradle and second cradle, and wherein the support bar is configured to extend between the first cradle and second cradle, and wherein the support bar is configured to rotate within the first cradle and second cradle;
a first tilt bar substantially parallel to the support bar, the first tilt bar separated from the support bar;
a second tilt bar substantially parallel to the support bar, the second tilt bar separated from the support bar;
a first power tilt device attached to the wall piece, the first power tilt device including a first power tilt gear and a first motor, the first power tilt gear driven by the first motor, the first power tilt gear including a first spiral ramp, wherein the first tilt bar contacts the first spiral ramp, and wherein operation of the first motor rotates the first power tilt gear changing the position of the first tilt bar; and
a second power tilt device attached to the wall piece, the second power tilt device including a second power tilt gear and a second motor, the second power tilt gear driven by the second motor, the second power tilt gear including a second spiral ramp, wherein the second tilt bar contacts the second spiral ramp, and wherein operation of the second motor rotates the second power tilt gear changing the position of the second tilt bar.

15. The mount of claim 14, wherein the wall piece comprises a first wall portion and a second wall portion, and wherein the first cradle extends from the first wall portion at an angle not parallel with the wall portion, and wherein the second cradle extends from the second wall portion at an angle not parallel with the wall portion, and wherein the first cradle comprises a first latch, and wherein the second cradle comprises a second latch, and wherein the first latch is configured to alternate between an open configuration such that the support bar can be placed in the first cradle and a closed configuration such that the support bar cannot be removed from the first cradle, and wherein the second latch is configured to alternate between an open configuration such that the support bar can be placed in the second cradle and a closed configuration such that the support bar cannot be removed from the second cradle.

16. The mount of claim 15 wherein the first tilt bar includes at least a first surface and a second surface, the first surface substantially perpendicular to the second surface and wherein the first surface and second surface interface at a radiused portion, and wherein the first tilt bar extends between the first wall portion and second wall portion.

17. The mount of claim 16 wherein the wall piece includes a base portion connecting the first wall portion and the second wall portion, and wherein the base portion is substantially planar, and wherein the first tilt bar rotates between a down position wherein the first surface is substantially parallel with the base portion and an up position wherein the first surface defines a non-zero angle with respect to the base portion.
